(19) United States
(12) Patent Application Publication
(10) Pub. No.: US 2022/0055636 A1
(43) Pub. Date: Feb. 24, 2022

(54) Control Architecture for a Vehicle

(71) Applicant: KNORR-BREMSE SYSTEME FÜR NUTZFAHRZEUGE GMBH, München (DE)

(72) Inventors: Csaba KOKREHEL, Budapest (HU); Huba NEMETH, Budapest (HU); Tamas RAPP, Budapest (HU); Peter SZELL, Budapest (HU)

(21) Appl. No.: 17/277,146

(22) PCT Filed: Sep. 3, 2019
(86) PCT No.: PCT/EP2019/073470

§ 371 Date: Mar. 17, 2021

(30) Foreign Application Priority Data
Sep. 18, 2018 (EP) 18195299.5

(51) Int. Cl. B60W 50/023; G05B 19/042

(52) U.S. Cl. CPC B60W 50/023; G05B 19/0421; G05B 2219/2637; G05B 2219/2237; G05B 2219/2231

(57) ABSTRACT

A control architecture for a vehicle communicatively connects each of a plurality of controllers to all of a plurality of commanded components. Each of the plurality of controllers is configured to send commands to be executed by one or more of the plurality of commanded components. Each of the plurality of commanded components determines that one of the plurality of controllers is a master controller on the basis of at least one signal transmitted from at least one of the plurality of controllers to the plurality of commanded components.

### FIELD OF THE INVENTION

The present invention relates to a control architecture for a vehicle, and a control method for a control architecture of a vehicle.

### BACKGROUND OF THE INVENTION

Redundant control architecture is a common solution for safety relevant applications to reduce failure rates and thus improving safety level. Due to the spread of AD (Automated Driving) applications, redundant control architecture is widely used for different functions (e.g. environment sensing, perception, behavior planning, track planning, control of actuators, etc.) to achieve targeted safety level. However, in the application of redundant control architecture, the determination and signalization of master-slave role of controllers arises.

U.S. Pat. No. 9,195,232 describes methods and systems for compensating for common failures in fail operational systems. An example system may include a primary controller configured to perform functions of a vehicle such as propulsion braking and steering and a secondary controller configured in a redundant configuration with the primary controller. The controllers may perform cross-checks of each other and may each perform internal self-checks as well. Additionally, the system may include a control module configured to transfer control of the vehicle between the controllers based on detecting a fault. The control module may detect a common fault of the controllers that causes the control module to output a common fault signal. In response, the system may transfer of control to a safety controller configured to perform the vehicle functions until the system may transfer control back to the primary controller.

US20160009257 describes that a system includes an autonomous sub-system that includes first and second braking modules. Each of the modules includes a processor and a memory. The memory stores instructions executable by the processor for detecting a fault. The system further includes a brake sub-system programmed to actuate a brake mechanism in response to a signal from the second braking module. The autonomous sub-system is further programmed to select one of the braking modules to provide a signal to the brake mechanism depending on whether a fault is detected.

However, there is a need to provide a means to identify a master-slave relationship role of controllers for commanded components.

Therefore, it would be advantageous to have an improved technology to identify a master-slave relationship role of controllers for commanded components.

### SUMMARY OF THE INVENTION

This need is met with the subject matter of the independent claims, wherein further embodiments are incorporated in the dependent claims. It should be noted that the following described aspects of the invention apply also for the control architecture for a vehicle and the control method for a control architecture of a vehicle.

In a first aspect, there is provided a control architecture for a vehicle, the control architecture comprising:

a plurality of controllers; and

a plurality of commanded components.

Each of the plurality of controllers is communicatively connected to all of the plurality of commanded components. Each of the plurality of controllers is configured to send commands to be executed by one or more of the plurality of commanded components. Each of the plurality of commanded components is configured to determine that one of the plurality of controllers is a master controller on the basis of at least one signal transmitted from at least one of the plurality of controllers to the plurality of commanded components.

In this way, a mechanism is provided to identify master-slave roles of controllers for commanded components, within a redundant control architecture, through signalling of appropriate transmitted information, such as wake up timing information.

Thus, even if only one controller is able to transmit it can be determined to be the master controller.

In this manner, master-slave role of the controllers can be signalized for the commanded components by a dedicated wake up line information from each controller.

In an example, the at least one signal comprises a trigger signal.

In an example, the at least one signal comprises a wake up signal.

Thus, upon system start-up the master-slave roles of controllers can be determined.

In an example, the at least one signal comprises at least two signals transmitted from at least two controllers of the plurality of controllers. The controller of the at least two controllers from which a signal is received first is determined as the master controller.

In this way, a simple manner is provided by which commanded components can determine which controller is the master controller, on the basis of a signal being received from this controller before signals being received (which may not need to be received) from other controllers. This also provides a simple manner in which a controller of the plurality of controllers can be selected to be the master controller, in that this controller will send its signal first.

Thus, the master-slave role of the controllers can be signalized on wake up lines by a trigger event at start up in such a way that the controller by which the trigger event is sent the first time is determined as master.

In an example, the at least one signal comprises a signal transmitted from a controller other than a previously determined master controller.

In other words, the master-slave role can be changed during the operation through is signalling by a new trigger event on the wake up line from the slave controller, that then becomes the master controller.

In an example, the at least one signal comprises a signal transmitter from a previously determined controller.

In other words, the master-slave role change during the operation can be overridden by the so far determined master controller issuing a new trigger event on the wake up line.

In an example, the plurality of controllers are communicatively connected together, and wherein a controller of the plurality of controllers is selected as the master controller.

In an example, the controller selected as the master controller is configured to transmit a signal to the plurality of commanded components before the other controllers of the plurality of controllers transmit signals to the plurality of commanded components.

This provides a simple manner in which a controller of the plurality of controllers can be selected to be the master controller, in that this controller will send its signal first. However, because the other controllers also send their signals, if for some reason a controller selected to be master controller has a fault or there is a fault on the connection between it and the commanded components, another controller will be automatically determined by the commanded components as the master controller. This is because those commanded components will first receive a message from this controller that is then determined to be the master controller thereby providing for effective redundancy.

In a second aspect, there is provided a control method for a control architecture of a vehicle, the method comprising:

a) communicatively connecting each of a plurality of controllers to all of a plurality of commanded components, wherein, each of the plurality of controllers is configured to send commands to be executed by one or more of the plurality of commanded components;
b) determining by each of the plurality of commanded components that one of the plurality of controllers is a master controller on the basis of at least one signal transmitted from at least one of the plurality of controllers to the plurality of commanded components.

In this manner, a method is provided to determine the master-slave role of controllers for lower level commanded components (even if they are identical in HW and SW). The method is based on the each controller having a communication line to each of the commanded components, that can be a dedicated wake-up line towards the commanded components, and the master-slave role can be determined according to the wake-up time sequence of controllers.

In an example, step b) comprises transmitting at least two signals transmitted from at least two controllers of the plurality of controllers, and determining the controller of the at least two controllers from which a signal is received first as the master controller.

The above aspects and examples will become apparent from and be elucidated with reference to the embodiments described hereinafter.

Exemplary embodiments will be described in the following with reference to the following drawings.

### BRIEF DESCRIPTION OF THE DRAWINGS

FIG. 1 is a schematic representation of an example of a control architecture for a vehicle; and

FIG. 2 shows a control method for a control architecture of a vehicle.

### DETAILED DESCRIPTION OF EMBODIMENTS

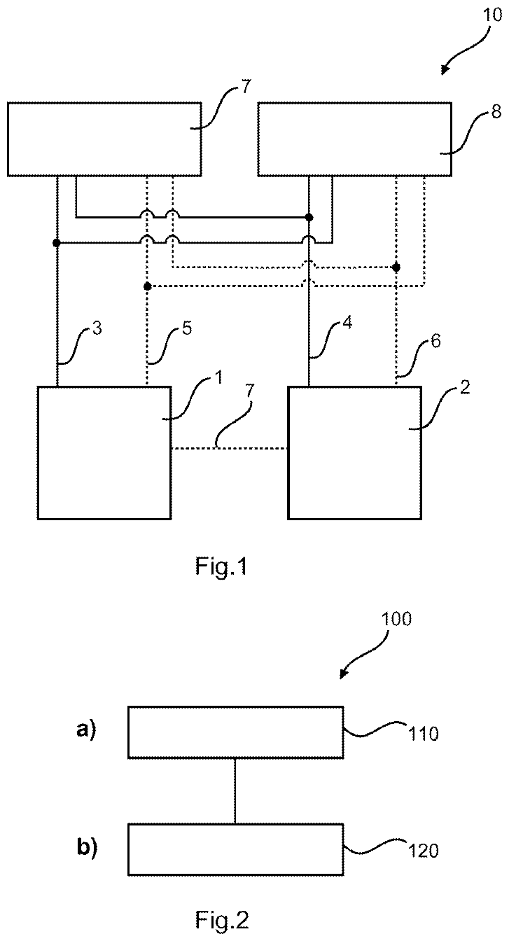

FIG. 1 shows an example of a control architecture 10 for a vehicle. The control architecture 10 comprises a plurality of controllers 1, 2, and a plurality of commanded components 7, 8. Each of the plurality of controllers is communicatively connected 3, 4, 5, 6 to all of the plurality of commanded components. This can be via wired or wireless communication. Each of the plurality of controllers is configured to send commands to be executed by one or more of the plurality of commanded components. Each of the plurality of commanded components is configured to determine that one of the plurality of controllers is a master controller on the basis of at least one signal transmitted from at least one of the plurality of controllers to the plurality of commanded components.

In an example, each controller is communicatively connected to each commanded component through a dedicated wake-up line.

In an example, each controller is communicatively connected to each commanded component through a communication line.

In an example, the plurality of commanded components are configured to execute commands sent to them by the determined master controller.

According to an example, the at least one signal comprises a trigger signal.

According to an example, the at least one signal comprises a wake up signal.

In an example, a signal transmitted can be a trigger signal that is a combination of a wake up line state change transmitted over a wake-up line and additional information sent over a corresponding communication line.

According to an example, the at least one signal comprises at least two signals transmitted from at least two controllers of the plurality of controllers. The controller of the at least two controllers from which a signal is received first is determined as the master controller.

According to an example, the at least one signal comprises a signal transmitted from a controller other than a previously determined master controller.

According to an example, the at least one signal comprises a signal transmitter from a previously determined controller.

According to an example, the plurality of controllers are communicatively connected 7 together, and wherein a controller of the plurality of controllers is selected as the master controller.

In an example, the master slave role of the controller is decided within the controllers using appropriate algorithms, that can be aligned via the connection between the controllers.

In an example, the plurality of controllers are configured to wake up through receipt of an appropriate signal, that for example can be triggered by the ignition line of the vehicle.

According to an example, the controller selected as the master controller is configured to transmit a signal to the plurality of commanded components before the other controllers of the plurality of controllers transmit signals to the plurality of commanded components.

FIG. 2 shows a control method 100 for a control architecture of a vehicle in its basic steps. The method comprises:

in a connecting step 110, also referred to as step a), communicatively connecting each of a plurality of controllers 1, 2 to all of a plurality of commanded components 7, 8. Each of the plurality of controllers is configured to send commands to be executed by one or more of the plurality of commanded components;

in a determining step 120, also referred to as step b), determining by each of the plurality of commanded components that one of the plurality of controllers is a master controller on the basis of at least one signal transmitted from at least one of the plurality of controllers to the plurality of commanded components.

In an example, the at least one signal comprises a trigger signal.

In an example, the at least one signal comprises a wake up signal.

According to an example, step b) comprises transmitting at least two signals transmitted from at least two controllers of the plurality of controllers, and determining the controller of the at least two controllers from which a signal is received first as the master controller.

In an example, the at least one signal comprises a signal transmitted from a controller other than a previously determined master controller.

In an example, the at least one signal comprises a signal transmitter from a previously determined controller.

In an example, the plurality of controllers are communicatively connected together, and wherein a controller of the plurality of controllers is selected as the master controller.

In an example, the controller selected as the master controller is configured to transmit a signal to the plurality of commanded components before the other controllers of the plurality of controllers transmit signals to the plurality of commanded components.

A detailed example is now described, again using FIG. 1. In this detailed example, a redundant controller architecture is shown, with at least two controllers (which can microcontrollers or complete ECUs) 1, 2 with dedicated wake-up lines 3, 4, which are connected to commanded components 7, 8. The controllers also have dedicated communication lines 5, 6 towards the commanded components and there is an interlink communication 7 between the controllers. The commanded components access both wake up lines 3 and 4 as well as both communication lines 5 and 6 at the same time, to be able to be commanded by any of the controllers 1 or 2 if the master role changes.

When the system is started, first the controllers 1 and 2 are triggered to wake up, e.g. by the ignition line of the vehicle. The master-slave role between controllers 1 and 2 is determined during the initialization phase by appropriate algorithms, which can be aligned through the interlink line 7. Then, the commanded components are triggered to wake up using the wake up lines 3 and 4. Each controller is triggering its wake up line towards the commanded components in the timing order according to its priority level (i.e. master first, slave second). The triggering on the wake up line can be signalized by an appropriate state change, which is complex enough that it cannot be produced by a controller in malfunction (e.g. sequence of state changes with specified timing). The commanded component is listening to the wake up lines in parallel and the master is identified by the wake up line that is triggered the first time—i.e. the line on which a signal is first received. In case the master-slave role needs to be changed (in case of failure of the other controller) then the slave controller can issue a new wake up trigger. In such a case, if the master in not inhibiting role change by another wake up trigger then the slave takes over the master role. If only one controller was able to start up at ignition, then in this case only the corresponding wake up line is triggered (no slave trigger) and the associated controller is determined to be the master controller. Alternatively, the trigger signal can be a combination of a wake up line state change and additional information sent to the corresponding communication line. The commanded component can then execute the commands sent over the communication line of the master 5 or 6.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

### LIST OF REFERENCE NUMBERS

An control architecture for a vehicle;
1, 2 Controllers;
3, 4 Wake-up lines;
5, 6 Communication lines;
7, 8 Commanded components;
100 A control method for a control architecture of a vehicle;
110 Communicatively connecting each of the controllers to all of the commanded components;
120 Determining by each of the plurality of commanded components that one of the plurality of controllers is a master controller.

1.-10. (canceled)

11. A control architecture for a vehicle, the control architecture comprising:
a plurality of controllers; and
a plurality of commanded components;
wherein each of the plurality of controllers is communicatively connected to all of the plurality of commanded components,
wherein each of the plurality of controllers is configured to send commands to be executed by one or more of the plurality of commanded components, and
wherein each of the plurality of commanded components is configured to determine that one of the plurality of controllers is a master controller on the basis of at least one signal transmitted from at least one of the plurality of controllers to the plurality of commanded components.

12. The control architecture according to claim 11, wherein the at least one signal comprises a trigger signal.

13. The control architecture according to claim 11, wherein the at least one signal comprises a wake up signal.

14. The control architecture according to claim 11, wherein
the at least one signal comprises at least two signals transmitted from at least two controllers of the plurality of controllers, and
the controller of the at least two controllers from which a signal is received first is determined as the master controller.

15. The control architecture according to claim 11, wherein
the at least one signal comprises a signal transmitted from a controller other than a previously determined master controller.

16. The control architecture according to claim 15, wherein
the at least one signal comprises a signal transmitted from a previously determined master controller.

17. The control architecture according to claim 11, wherein
the plurality of controllers are communicatively connected together, and
a controller of the plurality of controllers is selected as the master controller.

18. The control architecture according to claim 17, wherein
the controller selected as the master controller is configured to transmit a signal to the plurality of commanded components before the other controllers of the plurality of controllers transmit signals to the plurality of commanded components.

19. A control method for a control architecture of a vehicle, the method comprising:
a) communicatively connecting each of a plurality of controllers to all of a plurality of commanded components, wherein each of the plurality of controllers is configured to send commands to be executed by one or more of the plurality of commanded components;
b) determining, by each of the plurality of commanded components, that one of the plurality of controllers is a master controller on the basis of at least one signal transmitted from at least one of the plurality of controllers to the plurality of commanded components.

20. The method according to claim 19, wherein step b) comprises:
transmitting at least two signals transmitted from at least two controllers of the plurality of controllers, and determining the controller of the at least two controllers from which a signal is received first as the master controller.
